(19) United States
(12) Patent Application Publication
(10) Pub. No.: US 2022/0391055 A1
(43) Pub. Date: Dec. 8, 2022

(54) DISPLAY APPARATUS, DISPLAY SYSTEM, AND DISPLAY METHOD

(71) Applicants: Taira Oyama, Kanagawa (JP); Chika Nakano, Osaka (JP)

(72) Inventors: Taira Oyama, Kanagawa (JP); Chika Nakano, Osaka (JP)

(73) Assignee: Ricoh Company, Ltd., Tokyo (JP)

(21) Appl. No.: 17/664,263

(22) Filed: May 20, 2022

(30) Foreign Application Priority Data
May 28, 2021 (JP) 2021-089909
Apr. 4, 2022 (JP) 2022-062240

(51) Int. Cl. G06F 3/0483; G06F 3/0482

(52) U.S. Cl. CPC G06F 3/0483; G06F 3/0482; G06F 3/0488

(57) ABSTRACT

A display apparatus includes circuitry to display a selection window presenting a plurality of attributes of objects included in one or more pages, receive an operation of selecting an attribute from the plurality of attributes on the selection window, and display a collective view of one or more pages each of which is associated with the attribute selected on the selection window.

### CROSS-REFERENCE TO RELATED APPLICATIONS

This patent application is based on and claims priority pursuant to 35 U.S.C. § 119(a) to Japanese Patent Application Nos. 2021-089909, filed on May 28, 2021, and 2022-062240, filed on Apr. 4, 2022, in the Japan Patent Office, the entire disclosure of which is hereby incorporated by reference herein.

### BACKGROUND

### Technical Field

Embodiments of the present disclosure relate to a display apparatus, a display system, and a display method.

### Related Art

There are display apparatuses such as electronic whiteboards having a touch panel display that displays a hand drafted data drawn by strokes input by a user with an input device, such as a dedicated electronic pen, or a finger. Hand drafted data or the like added to a page displayed on the display of the display apparatus is stored, for each page, as an object in association with the page in addition to information on attribute, for example, the type and color of the data. Data displayed on the display (for example, display data of one screen image) is stored in a unit of one page.

There is a technique of providing a collective view displaying certain pages out of pages having been displayed on a display in a meeting, for the purpose of, for example, confirmation after the meeting.

### SUMMARY

In an embodiment, a display apparatus includes circuitry to display a selection window presenting a plurality of attributes of objects included in one or more pages, receive an operation of selecting an attribute from the plurality of attributes on the selection window, and display a collective view of one or more pages each of which is associated with the attribute selected on the selection window.

In another embodiment, a display system includes a display apparatus including first circuitry, and a server including second circuitry. The including first circuitry of the display apparatus displays a selection window selectively presenting a plurality of attributes of objects included in one or more pages, receives an operation of selecting an attribute from the plurality of attributes on the selection window, and transmit, to a server, information on the attribute selected on the selection window. The second circuitry of the server generates screen image information representing a collective view of one or more pages each of which is associated with the attribute selected on the selection window, and transmits the screen image information to the display apparatus. The first circuitry of the display apparatus receives the screen image information from the server, and displays the collective view based on the screen image information.

In another embodiment, a display method includes displaying, on a display, a selection window selectively presenting a plurality of attributes of objects included in one or more pages; receiving an operation of selecting an attribute from the plurality of attributes on the selection window; and displaying a collective view of one or more pages each of which is associated with the attribute selected on the selection window.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a collective view of pages (displaying all pages) displayed by a display apparatus according to embodiments of the present disclosure;

FIG. 2 is a diagram illustrating an example of a collective view of pages (displaying pages matching an attribute item selected by a user) displayed by the display apparatus according to embodiments;

FIG. 3 is a schematic view of an example of the display apparatus according to embodiments;

FIG. 4 is a schematic diagram illustrating examples of a configuration of a display system including the display apparatus according to embodiments;

FIG. 5 is a block diagram illustrating an example of a hardware configuration of the display apparatus according to embodiments;

FIG. 6 is a block diagram illustrating an example of a hardware configuration applicable to a server and a communication terminal of the display system according to embodiments;

FIG. 7 is a block diagram illustrating an example of a functional configuration of the display apparatus according to one embodiment;

FIG. 8 is a diagram illustrating a first example of a selection window (all-page view) for selecting an attribute item of pages to be included in a collective view displayed by the display apparatus according to embodiments;

FIG. 9 is a diagram illustrating a second example of the selection window (for filtering pages with attribute selected by a user) for selecting an attribute item of pages to be included in the collective view, displayed by the display apparatus according to embodiments; and

FIG. 10 is a flowchart illustrating an example of a sequence of operations for displaying a collective view of pages having an attribute item selected by a user according to the present embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

According to one or more embodiments of the present disclosure, a display system displays a collective view of pages each including an object having an attribute selected by a user.

Referring now to the drawings, descriptions are given of a display apparatus, a display system, and a display method according to embodiments of the present. As used herein, the singular forms “a,” “an,” and “the” are intended to include the plural forms as well, unless the context clearly indicates otherwise.

A first embodiment is described below.

In the present embodiment, a display system stores, in units of pages, data displayed on a display of a display apparatus such as an electronic whiteboard in, for example, a meeting. The display system provides a collective view displaying one or more pages matching an attribute item selected by a user on the display apparatus 2. A “page” in this disclosure is a unit for storing data displayed on a display and represents, for example, data of one screen image. Each page holds (or is associated with) information on attributes indicating whether or not image data is included, information on an object such as a character or a graphic input by an input device such as an electronic pen or a finger in a meeting, and information such as an identification (ID) identifying the meeting (meeting ID). From these pieces of attribute information, the user selects one or more attribute items specifying, for example, whether the page includes image data, whether the page includes an object hand drafted using an input device (e.g., an electronic pen or a finger), whether the page includes an object input in the current meeting, and the color of the object. The display apparatus 2 executes filtering for extracting pages having information indicating the attribute selected by a user from all pages displayed in a meeting, and collectively displays only the extracted pages (i.e., collective view).

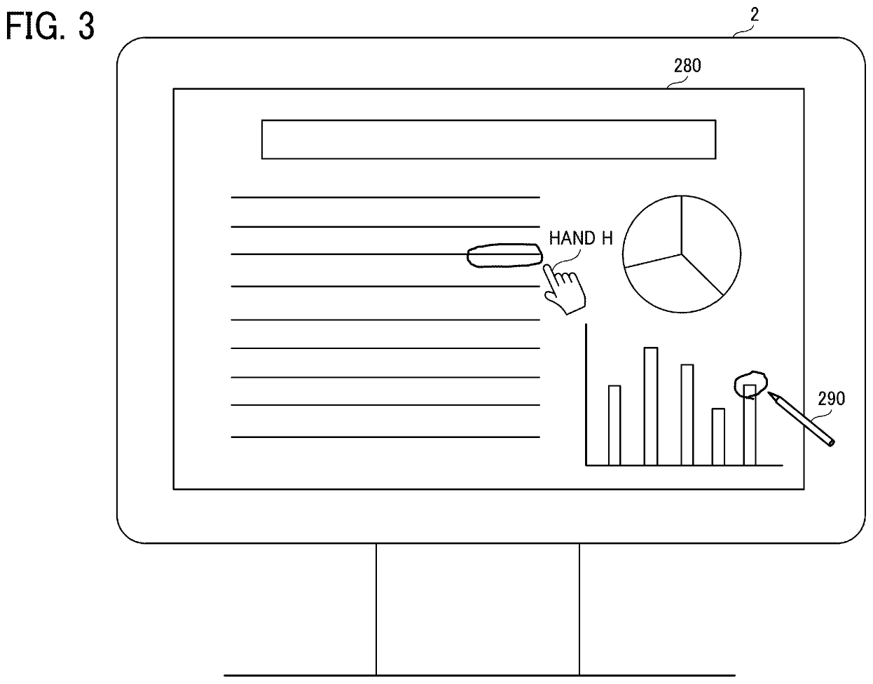

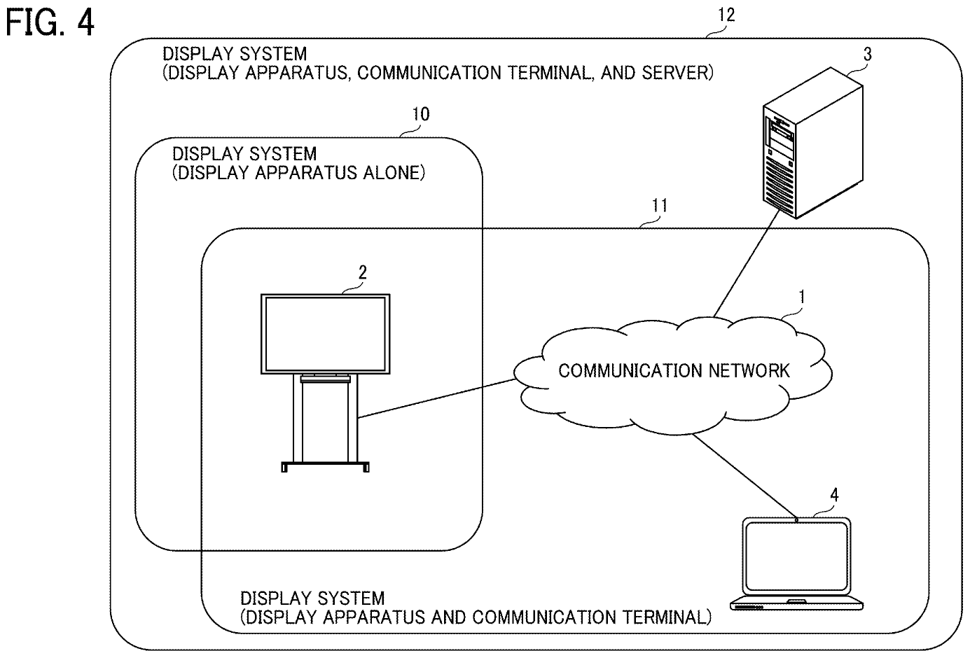

Terms A “display screen” represents a screen image displayed on the display of the display apparatus 2. In addition to the display screen, terms such as a “collective view” and a “selection window” are used to represent a specific manner of display or a specific display region. The display screen, the collective view, the selection window, and the like are not limited to those in full-screen display but may extend in a part of the display area of the display. Information or data for displaying a display screen on the display is referred to as screen image information. A display apparatus 2 (see FIG. 3) according to embodiments receives the screen image information generated by a server 3 (see FIG. 4) and displays a display screen (screen image) on a display based on the received screen image information.

Examples of the “object” include hand drafted data added to a page, and is stored per page. Attribute information specifies an attribute of an object such as a meeting ID, the type of the object, and the color of the object. Types (an example of attribute) of objects includes hand-drafted, stamp, character-recognized input, and straight line, and includes a type specifying an object input method. The processing of “character-recognized input” includes converting hand drafted input by character recognition and may further include formatting the data in accordance with attributes such as size and character color designated in advance. An ID is an abbreviation of identification. For example, each meeting is assigned with, as a meeting ID, a character string that is a combination of different characters including symbols and numbers in order to identify the meeting. An ID is used for identifying other items than meetings in a similar manner.

A collective view is a view that collectively presents a plurality of pages displayed in one meeting or a plurality of meetings. In the collective view, the number of pages displayed at a time is adjustable. Furthermore, the display system according to the present embodiment determines one or more pages to be included in the collective view based on the information on the attribute of the object included in the page, selected by the user, and displays a collective view of only the determined pages.

“Input device” may be any means with which a user inputs hand drafting by designating coordinates on a touch panel. Examples thereof include a pen, a human finger, a human hand, and a bar-shaped member. A series of user operations including engaging a writing mode, recording movement of an input device (e.g., a pen) or portion of a user, and then disengaging the writing mode is referred to as a stroke. The engaging of the writing mode may include, if desired, pressing an input device against a display or screen, and disengaging the writing mode may include releasing the input device from the display or screen. Alternatively, a stroke includes tracking movement of the portion of the user without contacting a display or screen. In this case, the writing mode may be engaged or turned on by a gesture of a user, pressing a button by a hand or a foot of the user, or otherwise turning on the writing mode, for example using a pointing device such as a mouse. The disengaging of the writing mode can be accomplished by the same or different gesture used to engage the writing mode, releasing the button, or otherwise turning off the writing mode, for example using the pointing device or mouse. “Stroke data” is data based on a trajectory of coordinates of a stroke input with the input device. The stroke data may be interpolated appropriately. “Hand drafted data” is data having one or more stroke data by hand drafted input. “Hand drafted data” is used for displaying (reproducing) a display screen including objects hand-drafted by the user. “Hand drafted input” relates to a user input such as handwriting, drawing, and other forms of input. The hand drafted input may be performed via touch interface, with a tactile object such as a pen or stylus or with the user's body. The hand drafted input may also be performed via other types of input, such as gesture-based input, hand motion tracking input or other touch-free input by a user.

“Filtering” is processing of determining a page to be displayed in the collective view from stored pages having been displayed in one or more meetings based on information on attributes of objects on pages, selected by the user. This processing may be referred to as filter processing, filtering, or filtering processing.

### Overview of Operation

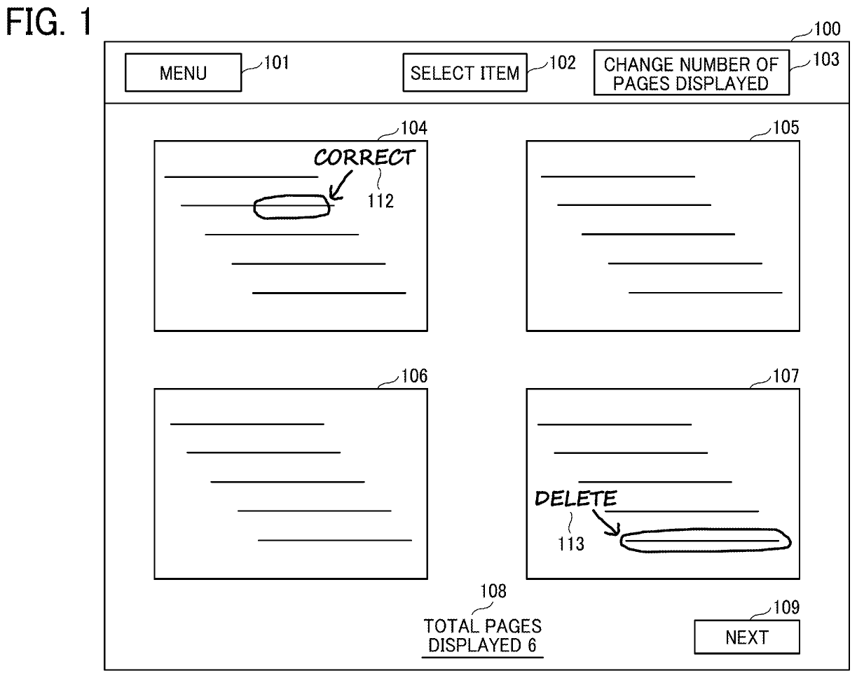

FIG. 1 is a diagram illustrating an example of a collective view (all-page view) displayed by the display apparatus 2 according to embodiments of the present disclosure. In FIG. 1, a collective view displayed on a display screen 100 includes four pages 104 to 107. The pages 104 and 107 include a hand-drafted object 112 “CORRECT” and a hand-drafted object 113 “DELETE,” respectively. A total displayed page number filed 108 at the center in a lower portion of the display screen 100 indicates that the number of displayed pages is six in total. In the lower right portion of the display screen 100, a screen transition button 109 labelled as “next” is displayed. In response to pressing of the screen transition button 109, the display apparatus 2 displays a collective view including the remaining pages.

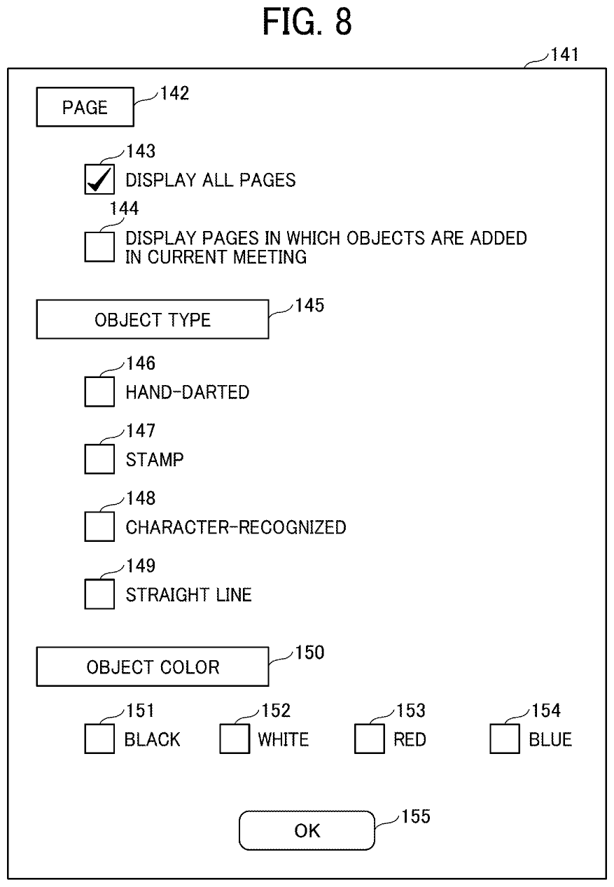

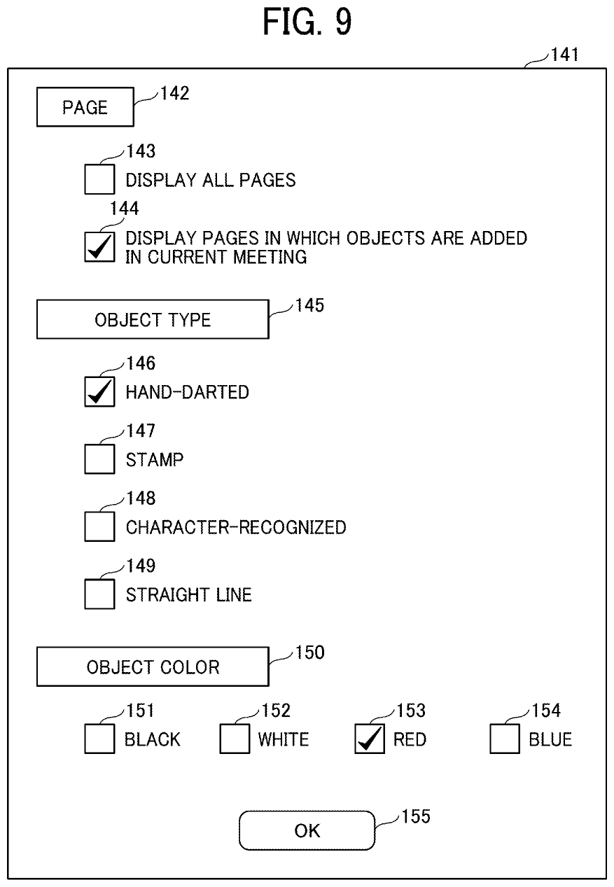

In an upper portion of the display screen 100, a menu button 101, a select item button 102, and a button 103 labelled as “change number of pages displayed” are arranged. In response to pressing of the menu button 101, the display apparatus 2 displays a menu window for performing switching between the collective view and a view presenting a single page, selecting a file to be displayed, setting the display apparatus 2, and the like. In response to pressing of the select item button 102, the display apparatus 2 displays a selection window for selecting information on attributes given to pages to be displayed in the collective view. Details of the selection window will be described later with reference to FIGS. 8 and 9. In response to pressing of the button 103 labelled as “change number of pages displayed,” the display apparatus 2 provides a user interface for changing the number of pages to be displayed at a time in the collective view from the current number of 4 to, for example, 8, 12, 16, or 20.

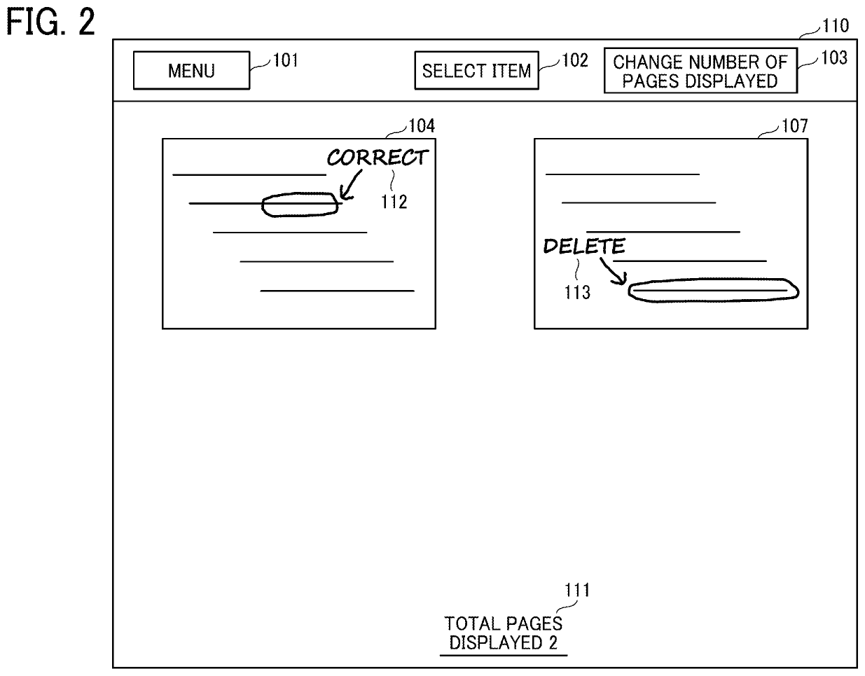

FIG. 2 is a diagram illustrating an example of a collective view of pages (displaying pages matching an attribute item selected by a user) displayed by the display apparatus 2 according to embodiments of the present disclosure. FIG. 2 illustrates an example of the collective view in a case where, on the selection window displayed in response to the user's pressing the select item button 102, the user has selected, as a condition for filtering displayed pages, pages including a hand drafted object.

The display screen 110 illustrated in FIG. 2 displays the collective view of the pages 104 and 107 including the hand drafted objects 112 and 113 out of the six pages illustrated in FIG. 1. The remaining two pages not displayed on the display screen 100 in FIG. 2 do not include hand drafted objects. The total displayed page number filed 111 at the center in the lower portion of the display screen 110 indicates that the number of displayed pages is two in total.

As described above, the display apparatus 2 according to embodiments of the present disclosure displays a collective view of pages including objects having an attribute (filtering condition) selected by a user, out of a plurality of stored pages displayed in one or more meetings.

### Example Structure of Display Apparatus

FIG. 3 is a schematic view of an example of the display apparatus 2 according to embodiments of the present disclosure. The user can input (draw) characters or the like on a display 280 with an input device such as a hand H or an electronic pen 290. Although the display apparatus 2 illustrated in FIG. 3 is placed landscape, the display apparatus 2 may be placed portrait.

The user can rotate the display apparatus 2 around the center of the display 280 as an axis for switching between the landscape placement and the portrait placement.

A description is given below of examples of a configuration of the display system.

FIG. 4 is a schematic diagram illustrating examples of the configuration of a display system including the display apparatus 2 according to embodiments of the present disclosure. FIG. 4 illustrates, as three examples of the display systems including the display apparatus 2, a display system 10 including the display apparatus 2 alone, a display system 11 including the display apparatus 2 and a communication terminal 4, and a display system 12 including the display apparatus 2, the communication terminal 4, and the server 3. In response to a request from the display apparatus 2, the server 3 transmits a file or information about a display screen to be displayed on the display apparatus 2 to the display apparatus 2. The communication terminal 4 transmits a file of, for example, an image or a document to the display apparatus 2. In addition, the communication terminal 4 displays, on a display thereof, a display screen based on data received from the display apparatus 2, and receives an operation on the display screen by the user.

In the display system 10, the display apparatus 2 is used alone. In this case, although the display apparatus 2 is not connected to a communication network 1, a universal serial bus (USB) memory 230 storing a file may be connected to the display apparatus 2, and the file may be transferred to a storage device such as a solid state drive (SSD) 204 of the display apparatus 2.

In the display system 11, the display apparatus 2 and the communication terminal 4 communicate with each other via the communication network 1. In this case, the communication network 1 is, for example, a local area network (LAN), and may be a wired local area network (LAN) or a wireless LAN. Alternatively, the display apparatus 2 and the communication terminal 4 may be directly connected by a LAN cable or a USB cable, or may be directly connected by wireless communication such as a wireless LAN or BLUETOOTH. In the display system 11, a file such as an image or a document created by the communication terminal 4 can be transferred to the display apparatus 2 via the communication network 1.

Alternatively, in the display system 11, the communication terminal 4 may receive a user operation regarding, for example, display of a page on the display apparatus 2 via the communication network 1, or a display screen of the display apparatus 2 may be displayed on the communication terminal 4 via the communication network 1.

In the display system 12, the display apparatus 2, the communication terminal 4, and the server 3 communicate with each other via to the communication network 1. In this case, for example, the communication network 1 may be a LAN similarly to the display system 11, and the server 3 may be connected via an external network such as the Internet or a cloud network. In this case, as in the display system 11, a file stored in the communication terminal 4 or the server 3 may be transferred to the display apparatus 2 via the communication network 1. Alternatively, a client-server relationship in which the display apparatus 2 is a client and the server 3 is a server may be established in the display system 12 so that the server 3 generates a screen image data and transmit the screen image data to the display apparatus 2 in response to a request from the display apparatus 2. The server 3 may be implemented by one server or may be implemented by a plurality of servers in a distributed manner.

The first embodiment concerns the display system 10 in which the display apparatus 2 is not connected via the communication network 1 to the server 3 or the communication terminal 4.

### Hardware Configuration

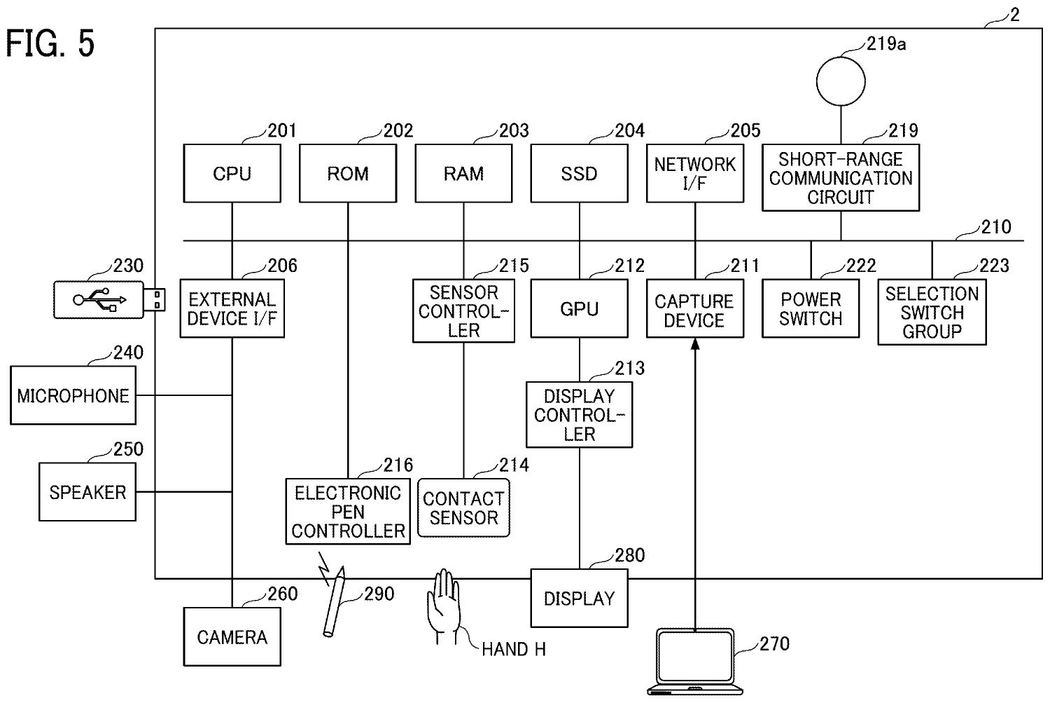

FIG. 5 is a block diagram illustrating an example of a hardware configuration of the display apparatus 2 according to embodiments. As illustrated in FIG. 5, the display apparatus 2 includes a central processing unit (CPU) 201, a read only memory (ROM) 202, a random access memory (RAM) 203, a solid state drive (SSD) 204, a network interface (I/F) 205, and an external device I/F 206.

The CPU 201 controls entire operation of the display apparatus 2. The ROM 202 stores a control program such as an initial program loader (IPL) to boot the CPU 201. The RAM 203 is used as a work area for the CPU 201. The SSD 204 stores various data such as a control program for the display apparatus 2. The network I/F 205 controls communication with an external device through the communication network 1.

The external device I/F 206 is an interface for connecting various external devices to the display apparatus 2. Examples of the external devices include, but are not limited to, the universal serial bus (USB) memory 230 and external devices (a microphone 240, a speaker 250, and a camera 260).

The display apparatus 2 further includes a capture device 211, a graphics processing unit (GPU) 212, a display controller 213, a contact sensor 214, a sensor controller 215, an electronic pen controller 216, a short-range communication circuit 219, an antenna 219a of the short-range communication circuit 219, a power switch 222, and a selection switch group 223.

The capture device 211 causes a screen image of a personal computer (PC) 270 to display a still image or a video image based on image data. The GPU 212 is a semiconductor chip dedicated to graphics. The display controller 213 controls screen display to output an image processed by the GPU 212 to the display 280. The contact sensor 214 detects a touch of the electronic pen 290 or the user's hand H onto the display 280. The sensor controller 215 controls operation of the contact sensor 214. The contact sensor 214 inputs and detects coordinates by an infrared blocking system.

The inputting and detecting a coordinate may be as follows. For example, two light receiving and emitting devices are disposed at both ends of the upper face of the display 280, and a reflector frame surrounds the periphery of the display 280. The light receiving and emitting devices emit a plurality of infrared rays in parallel to a surface of the display 280. The rays are reflected by the reflector frame, and a light-receiving element receives light returning through the same optical path of the emitted infrared rays. The contact sensor 214 outputs an identifier (ID) of the infrared ray that is blocked by an object after being emitted from the two light receiving and emitting devices, to the sensor controller 215. Based on the ID of the infrared ray, the sensor controller 215 detects specific coordinates that is touched by the object. The electronic pen controller 216 communicates with the electronic pen 290 to detect contact by the tip or bottom of the electronic pen with the display 280. The short-range communication circuit 219 is a communication circuit in compliance with, for example, the near field communication (NFC) or BLUETOOTH. The power switch 222 turns on or off the power of the display apparatus 2. The selection switch group 223 is a group of switches for adjusting brightness, hue, etc., of display on the display 280.

The display apparatus 2 further includes a bus line 210. The bus line 210 is an address bus or a data bus that electrically connects the elements illustrated in FIG. 5, such as the CPU 201, to each other.

The system of the contact sensor 214 is not limited to the infrared blocking system. Examples of the system employed by the contact sensor 214 include types of detector such as a capacitive touch panel that identifies the contact position by detecting a change in capacitance, a resistance film touch panel that identifies the contact position by detecting a change in voltage of two opposed resistance films, and an electromagnetic induction touch panel that identifies the contact position by detecting electromagnetic induction caused by contact of an object to the display. In addition to or alternative to detecting a touch by the tip or bottom of the electronic pen 290, the electronic pen controller 216 may also detect a touch by another part of the electronic pen 290, such as a part held by a hand of the user.

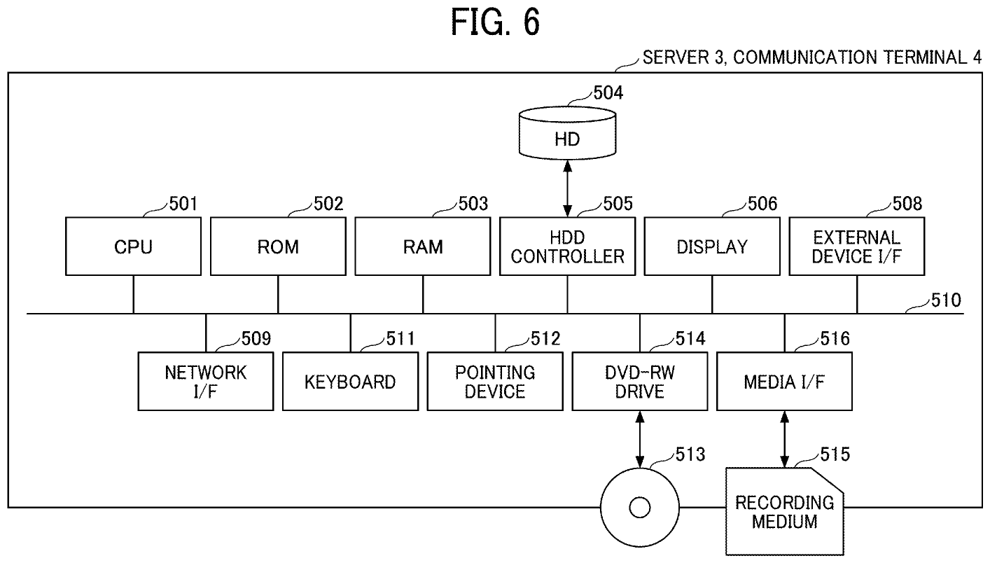

FIG. 6 is a block diagram illustrating an example of a hardware configuration applicable to the server 3 and the communication terminal 4 according to embodiments of the present disclosure. As illustrated in FIG. 6, the server 3 and the communication terminal 4 is, for example, a computer and includes a CPU 501, a ROM) 502, a RAM 503, a hard disk (HD) 504, a hard disk drive (HDD) controller 505, a display 506, an external device I/F 508, a network I/F 509, a data bus 510, a keyboard 511, a pointing device 512, a digital versatile disk-rewritable (DVD-RW) drive 514, and a media I/F 516.

The CPU 501 controls the entire operation of the server 3 (or the communication terminal 4). The ROM 502 stores programs, such as an IPL, for driving the CPU 501. The RAM 503 is used as a work area for the CPU 501. The HD 504 is a storage area that stores various data such as programs. The HDD controller 505 controls reading and writing of various data from and to the HD 504 under control of the CPU 501. The display 506 displays various information such as a cursor, a menu, a window, characters, and images. The external device I/F 508 is an interface for connecting to various external devices. Examples of the external devices include, but are not limited to, a universal serial bus (USB) memory and a printer. The network I/F 509 is an interface for data communication via a communication network 1. The data bus 510 is an address bus, a data bus, or the like that electrically connect components, such as the CPU 501, illustrated in FIG. 6.

The keyboard 511 is a kind of input device including a plurality of keys for inputting a character, a numerical value, various instructions, and the like. The pointing device 512 is an example of an input device that allows a user to select or execute various instructions, select an item for processing, or move a cursor being displayed. The DVD-RW drive 514 reads and writes various data from and to a DVD-RW 513, which is an example of a removable recording medium. The removable storage medium is not limited to the DVD-RW and may be a DVD-recordable (DVD-R) or the like. The media I/F 516 controls reading and writing (storing) of data from and to a recording medium 515 such as a flash memory.

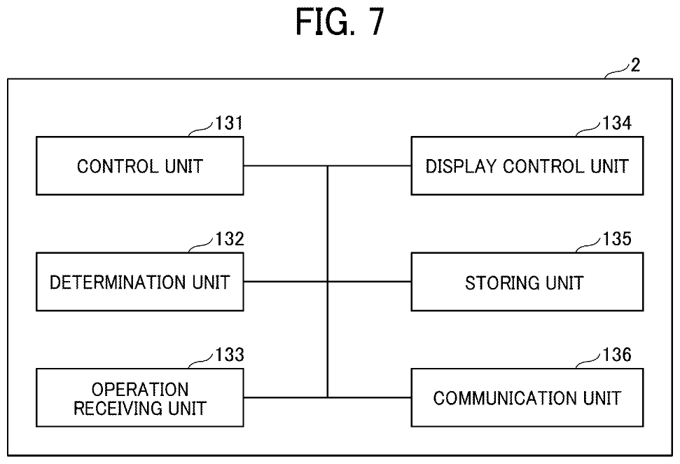

A description is given of a functional configuration of the display apparatus 2. FIG. 7 is a block diagram illustrating an example of the functional configuration of the display apparatus 2 according to the present embodiment. As illustrated in FIG. 7, the display apparatus 2 includes a control unit 131, a determination unit 132, an operation receiving unit 133, a display control unit 134, a storing unit 135, and a communication unit 136.

The control unit 131 executes processing related to displaying a collective view of pages including objects having an attribute selected by the user. For example, the control unit 131 generates page determination data used for determining a page to be displayed in the collective view, and adds the determined page to pages to be displayed in the collective view.

The determination unit 132 determines whether or not the page is to be displayed in the collective view using the page determination data generated by the control unit 131.

The operation receiving unit 133 receives an input operation such as hand drafted input with the hand H or the electronic pen 290 to the display 280 by the user.

The display control unit 134 displays, on the display 280, a display screen presenting, for example, a page, a collective view, or a selection window.

The storing unit 135 stores, in a memory, the page determination data generated by the control unit 131, and the page number of the page determined to be displayed in the collective view by the determination unit 132.

The communication unit 136 transmits and receives screen image information for displaying on the display 280 and user input information received by the operation receiving unit 133 to and from the server 3 or the communication terminal 4 via the communication network 1.

TABLE 1

| Object Id | Meeting Id | Object Type | Color |
|---|---|---|---|
| 0001 | M002 | Hand Drafted | Red |
| 0002 | M001 | Stamp | Black |
| 0003 | M001 | Character Recognized | Blue |
| 0004 | M002 | Hand Drafted | Red |
| 0005 | M001 | Character Recognized | Red |
| 0006 | M002 | Straight Line | White |

Table 1 presents an example of attributes of objects added to pages in the display apparatus 2 according to the present embodiment. There are four types of attributes of objects: object ID; meeting ID; object type; and color. Table 1 contains attributes of six objects.

The object ID is identification information (ID) identifying an object added to a page. For example, the object ID is a four-digit number.

The meeting ID is identification information (ID) identifying a meeting and associated with an object. For example, the meeting ID is a combination of a character M and a three-digit number.

Table 1 includes four object types: hand drafted; stamp; character-recognized input; and straight line, as examples. The object types are described below. “Hand drafted” represents data by hand drafted input. “Stamp” represents various types of small images prepared in advance, and the display system 10, 11, or 12 allows the user to dispose a designated stamp at a designated position on the display 280. “Character-recognized” represents hand drafted data having been converted by character recognition to be displayed and stored as character-recognized data. “Straight line” represents a straight line drawn on the display 280 by the user.

“Color” is a color of each of various objects when the object is displayed on the display 280. Table 1 includes four colors: black; white; red; and blue as examples.

TABLE 2

| | Presence of | |
|---|---|---|
| Page No. | Image | Object ID |
| 1 | No | |
| 2 | No | 0001 |
| 3 | No | 0002 |
| 4 | No | 0003, 0004 |
| 5 | No | 0005 |
| 6 | Yes | 0006 |

Table 2 presents examples of objects included in pages displayed by the display apparatus 2 according to embodiments of the present disclosure. Table 2 includes two types of information, “presence of image” and “object ID,” relating to objects included in pages.

“Presence of image” indicates whether or not an image is included in the page. When the page includes an image, an image file saved in a format such as Joint Photographic Experts Group (JPEG) is associated with the page, and the image is displayed at a designated position on the display 280.

“Object ID” represents an ID of the object included in the page, and the object ID identifies an object presented in Table 1.

TABLE 3

| | Meeting | Presence | Type of Object | | | | | | | |
|---|---|---|---|---|---|---|---|---|---|---|
| Page | ID of | of Image | Hand | | Character- | Straight | Color | | | |
| No. | Object | File | Drafted | Stamp | Recognized | Line | Black | White | Red | Blue |
| 1 | N/A | No | | | | | | | | |
| 2 | M002 | No | Yes | | | | | | Yes | |
| 3 | M001 | No | | Yes | | Yes | Yes | | | Yes |
| 4 | M001 | No | Yes | | | | | | Yes | |
| | M002 | | | | | | | | | |
| 5 | M001 | No | | | Yes | | | | Yes | |
| 6 | M002 | Yes | | | | Yes | | Yes | | |

Table 3 is an example of page determination data used for determining a page to be included in the collective view in the display apparatus 2 according to embodiments of the present disclosure. Table 3 includes attributes of objects referred to in determining a page to be included in the collective view. The information on attribute includes “page number,” “meeting ID of object,” “presence of image file,” “type of object,” and “color.”

The page number is a number identifying the page, and an example of page identifier.

The meeting ID of object is an ID identifying the meeting presented in Table 1, associated with the object included in the page.

The presence of image file is information indicating whether or not an image is included in the page presented in Table 2.

The type of object is information indicating, for each page, whether or not the object types presented in Table 1 are included, and “Yes” is in the cell corresponding to the object type.

The color is information indicating whether or not an object having any of the colors presented in Table 1 is included, and “Yes” is in the cell corresponding to the color of the object included in the page.

The page determination data is in the same state regardless of the attribute (of object) selected by the user unless a new object is added to a page in the next meeting or the like. The determination unit 132 performs determination of pages using the page determination data. Each time a page is updated, the control unit 131 generates page determination data. The generated page determination data is stored, and the control unit 131 generates and stores the updated page determination data only when a new object is added to the page, so as to reduce the processing load of the display apparatus 2 is reduced.

A description is given of a first example of selection window for selecting an attribute item related to pages to be included in the collective view.

FIG. 8 is a diagram illustrating an example of a selection window for selecting an attribute item related to the page to be included in the collective view, displayed by the display apparatus 2 according to embodiments of the present disclosure. A selection window 141 illustrated in FIG. 8 presents broad classifications of attributes to be selected by the user: a section “page” 142; a section “object type” 145; and a section “object color” 150. Each of the broad classifications includes specific attribute items selected by the user, each accompanied by check boxes. A check mark is displayed in the check box of the selected attribute item.

When a check box 143 of “display all pages” in the section “page” 142 is selected, all stored pages are displayed in the collective view. When a check box 144 of “display pages in which objects are added in current meeting” is selected, pages associated with the meeting ID of the current meeting are displayed in the collective view based on the information of “meeting ID of object” in Table 3. For example, when the current meeting has the meeting ID “M002,” pages 2, 3, and 6 associated with “M002” as the meeting ID of object in Table 3 are displayed in the collective view.

An arbitrary meeting ID may be designated.

When one or more of a check box 146 of “hand drafted,” a check box 147 of “stamp,” a check box 148 of “character-recognized,” and a check box 149 of “straight line” are selected in the section “object type” 145, the determination unit 132 determines whether or not to include the page in the collective view based on the information of “type of object” (included in the page) in Table 3. For example, when the check box 146 of “hand drafted” is selected, the pages 2 and 4 marked with “Yes” in “hand drafted” in “type of object” in Table 3 are included in the collective view.

When one of more of a check box 151 of “black,” a check box 152 of “white,” a check box 153 of “red,” and a check box 154 of “blue” in the section “object color” 150 are selected, the determination unit 132 determines whether or not to include the page in the collective view based on the attribute “color of object” in Table 3. For example, when the check box 151 of “black” is selected, the pages 3 and 5 in which “black” is marked with “Yes” in “color of object” in Table 3 are displayed in the collective view.

When the user presses an OK button 155, the page to be displayed in the collective view is determined based on the page determination data. Based on the determination result, a collective view including a page matching the selected attribute is displayed. In response to the user's pressing the OK button 155 after selecting the check box 143 of “display all pages” as a filtering condition as illustrated in FIG. 8, the display apparatus 2 displays a collective view including all the pages illustrated in FIG. 1.

A description is given of a second example of selection window for selecting an attribute item related to pages to be included in the collective view.

FIG. 9 is a diagram illustrating another example of the selection window (for filtering pages with attribute selected by the user) for selecting an attribute item related to the page to be included in the collective view, displayed by the display apparatus 2 according to embodiments of the present disclosure. The difference from FIG. 8 is that the selected attribute items are different. In FIG. 9, the check box 144 of “display pages in which objects are added in current meeting,” the check box 146 of “hand drafted,” and the check box 153 of “red” are marked. When the user presses the OK button 155 after selecting attribute items as illustrated in FIG. 9, the control unit 131 generates the page determination data illustrated in Table 3. The determination unit 132 determines pages to be displayed in the collective view based on the page determination data. As a result of this determination, the pages 2 and 4 determined to be displayed in the collective view, and the collective view of the pages including the hand drafted objects as illustrated in FIG. 2 is displayed. In this example, the pages satisfying both (logical conjunction/AND) of the check box 146 of “hand drafted” and the check box 153 of “red” are determined to be displayed in the collective view. Alternatively, pages may be determined whether one of these attributes is satisfied. When the determination is made under the latter condition, the page 5 is displayed in the collective view in addition to the pages 2 and 4.

A description is given of a sequence of operations for displaying a collective view.

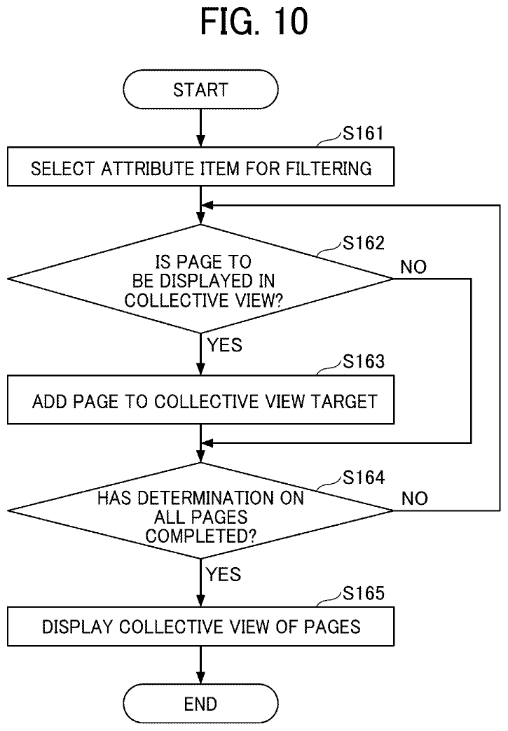

FIG. 10 is a flowchart illustrating an example of a sequence of operations for displaying a collective view of pages matching an attribute item selected by a user according to the present embodiment. A description is given of steps for displaying the collective view of pages matching an attribute item selected by the user in the display apparatus 2. The display apparatus 2 starts the process of FIG. 10, for example, when the display apparatus 2 is activated to display a screen.

Step S161: When the operation receiving unit 133 receives pressing of the select item button 102 illustrated in FIGS. 1 and 2 by the user, the display control unit 134 displays the selection window 141 illustrated in FIGS. 8 and 9. Next, the operation receiving unit 133 receives an operation of selection of an attribute for filtering (processing of determining a page to be displayed in a collective view) in the selection window 141 by the user. When the operation receiving unit 133 receives pressing of the OK button 155 illustrated in FIGS. 8 and 9, the control unit 131 generates page determination data illustrated in Table 3.The storing unit 135 stores in the memory the page determination data.

Step S162: The determination unit 132 selects a page to be determined as to whether the page is to be displayed in the collective view. Specifically, when this step is executed for the first time from the start of the sequence illustrated in FIG. 10, the determination unit 132 selects a page having a page number “1,” and thereafter increments the selected page number by one each time this step is executed.

The determination unit 132 checks whether or not the selected page includes an object having the attribute selected by the user, using the page determination data, thereby determining whether or not the selected page is to be displayed in the collective view. When the page is determined to be displayed in the collective view, the process transitions to step S163, and when not, the process transitions to step S164.

Step S163: The control unit 131 holds the page number of the page having been determined to be displayed in the collective view in step 162, and adds the page to collective view targets. Alternatively, the storing unit 135 may store the page number.

Step S164: The determination unit 132 checks whether the determination on all pages has completed. When the determination on all pages has completed, the process proceeds to step S165. When not, the process proceeds to step 162.

Step S165: The display control unit 134 displays, on the display 280, a collective view of pages determined to be displayed in the collective view.

Through the above processing, the display apparatus 2 displays, on the display 280, a collective view of only pages (e.g., as thumbnails) that match the attribute item selected by the user.

A second embodiment is described below.

The second embodiment concerns the display system 11 illustrated in FIG. 4 in which the display apparatus 2 and the communication terminal 4 communicate with each other via the communication network 1. In the present embodiment, of the functional units of the display apparatus 2 in FIG. 7, the operation receiving unit 133 resides in the communication terminal 4. In addition, the communication unit 136 of the display apparatus 2 transmits, to the communication terminal 4, information of an image displayed on the display 280, provided by the display control unit 134. Accordingly, the same screen image as that of the display apparatus 2 is displayed on the display 506 of the communication terminal 4. The communication terminal 4 allows the user to perform operation equivalent to the operation performed on the display apparatus 2, using the keyboard or the pointing device 512 of the communication terminal 4. The communication terminal 4 transmits the information or instruction input by the user and received by the operation receiving unit 133 to the communication unit 136 of the display apparatus 2. Thus, the display apparatus 2 receives the information or instruction input by the user.

In the present embodiment, the process of displaying the collective view of pages matching the item selected by the user is different from step S161 and step S165 of the first embodiment illustrated in FIG. 10. The differences will be described.

On the display 506 of the communication terminal 4, the collective view illustrated in FIG. 1 or 2 is displayed. S161: The operation receiving unit 133 of the communication terminal 4 receives pressing of the select item button 102 by the user. Differently from the first embodiment, operation receiving unit 133 transmits the received information to the communication unit 136 of the display apparatus 2. Receiving the information received by the communication unit 136, the display control unit 134 of the display apparatus 2 displays the selection window 141 illustrated in FIGS. 8 and 9. The communication unit 136 transmits the screen image information provided by the display control unit 134 to the communication terminal 4, and the communication terminal 4 displays an image on the display 506 based the received screen image information. The operation receiving unit 133 receives an operation of selection of an attribute item for filtering (processing of determining a page to be displayed in a collective view) in the selection window 141 by the user. When the operation receiving unit 133 receives pressing of the OK button 155 illustrated in FIGS. 8 and 9, the operation receiving unit 133 transmits the received information to the communication unit 136 of the display apparatus 2. Receiving the information received by the communication unit 136, the control unit 131 of the display apparatus 2 generates the page determination data presented in Table 3. The storing unit 135 stores in the memory the page determination data.

The subsequent steps 5162 to 5164 are the same as those in the first embodiment.

Step S165: The display control unit 134 displays, on the display 280, a collective view of pages having been determined as having the attribute selected by the user. The communication unit 136 transmits the screen image information provided by the display control unit 134 to the communication terminal 4, and the communication terminal 4 displays an image on the display 506 based the received screen image information.

Through the above-described processing, in the second embodiment, the display apparatus 2 displays a collective view of only pages that match the attribute item selected by the user on the display 280.

A third embodiment is described below.

The third embodiment concerns the display system 12 illustrated in FIG. 4 in which the display apparatus 2, the communication terminal 4, and the server 3 communicate with each other via the communication network 1. In the third embodiment, a client-server relationship in which the display apparatus 2 is a client and the server 3 is a server is established. The server 3 generates screen image information and transmit the screen image information to the display apparatus 2 in response to a request from the display apparatus 2. In the present embodiment, of the functional units of the display apparatus 2 in FIG. 7, the control unit 131, the determination unit 132, and the storing unit 135 reside in the server 3. Alternatively, as described in the second embodiment, the operation receiving unit 133 may also reside in the communication terminal 4.

In the present embodiment, the communication unit 136 of the display apparatus 2 receives screen image information representing an image to be displayed on the display 280 from the server 3 and transmits information input by the user and received by the operation receiving unit 133 to the server 3. The operations executed by the control unit 131, the determination unit 132, and the storing unit 135 are executed by the server 3.

In the present embodiment, the process of displaying the collective view of pages matching the attribute item selected by the user is different from step S161 and step S165 of the first embodiment illustrated in FIG. 10. The differences will be described.

Step S161: The operation receiving unit 133 of the display apparatus 2 receives pressing of the select item button 102 by the user. The communication unit 136 transmits the received information to the server 3. The server 3 transmits screen image information for displaying the selection window 141 illustrated in FIGS. 8 and 9 to the communication unit 136 of the display apparatus 2. The display control unit 134 displays an image on the display 280 based on the screen image information received by the communication unit 136. The operation receiving unit 133 receives an input of selection of an attribute item for filtering (processing of determining a page to be displayed in a collective view) in the selection window 141 by the user. When the operation receiving unit 133 receives pressing of the OK button 155 illustrated in FIGS. 8 and 9, the communication unit 136 transmits the received information to the server 3. Receiving the information received by the communication unit 136, the control unit 131 of the server 3 generates the page determination data presented in Table 3. The storing unit 135 stores in the memory the page determination data.

The server 3 performs the subsequent steps S162 to S164 similar to those performed in the first embodiment.

Step S165: The server 3 transmits screen image information representing a collective view of pages having been determined as having the attribute selected by the user to the communication unit 136 of the display apparatus 2. The display control unit 134 displays an image on the display 280 based on the screen image information received by the communication unit 136.

Through the above-described processing, in the third embodiment, the display apparatus 2 displays a collective view of only pages that match the attribute item selected by the user on the display 280.

The description above concerns some of embodiments of the present disclosure. Embodiments of the present disclosure are not limited to the specific embodiments described above, and various modifications and replacements are possible within the scope of aspects of the disclosure.

For example, FIG. 7 illustrates an example of the block diagram in which the functional units are divided into blocks in accordance with main functions of the display apparatus 2, in order to facilitate understanding of the operation by the display apparatus 2. Each processing unit or each specific name of the processing unit is not to limit the scope of the present disclosure. The processing implemented by the display apparatus 2 may be divided into a larger number of processing units depending on the content of the processing. In addition, a single processing unit can be further divided into a plurality of processing units.

Each of the functions of the described embodiments may be implemented by one or more processing circuits or circuitry.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The group of apparatuses or devices described above is one example of plural computing environments that implement the embodiments disclosed in this specification. In some embodiments, the display apparatus 2 or the server 3 includes multiple computing devices such as server clusters. The plurality of computing devices communicates with one another through any type of communication link including, for example, a network or a shared memory, and performs the operations described in the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

An embodiment of the present disclosure provides a non-transitory recording medium storing a plurality of program codes which, when executed by one or more processors, causes the processors to perform a method. The method includes:

displaying, on a display, a selection window selectively presenting a plurality of attributes of objects included in one or more pages;

receiving an operation of selecting an attribute from the plurality of attributes on the selection window; and

displaying a collective view of one or more pages each of which is associated with the attribute selected on the selection window.

1. A display apparatus comprising
circuitry configured to:
display a selection window presenting a plurality of attributes of objects included in one or more pages;
receive an operation of selecting an attribute from the plurality of attributes on the selection window; and
display a collective view of one or more pages each of which is associated with the attribute selected on the selection window.

2. The display apparatus according to claim 1,
wherein each of the plurality of attributes specifies one of an input method of the object, a color of the object, and a meeting associated with the object.

3. The display apparatus according to claim 1,
wherein the circuitry:
generates page determination data used in determining the one or more pages to be included in the collective view; and
determines the one or more pages each of which is associated with the attribute selected on the selection window, using the page determination data.

4. The display apparatus according to claim 3,
wherein the page determination data associates, for each page, a page identifier with the attribute of the object included in the page.

5. A display system comprising:
a display apparatus including first circuitry configured to:
display a selection window selectively presenting a plurality of attributes of objects included in one or more pages;
receive an operation of selecting an attribute from the plurality of attributes on the selection window; and
transmit, to a server, information on the attribute selected on the selection window; and
the server including second circuitry configured to:
generate screen image information representing a collective view of one or more pages each of which is associated with the attribute selected on the selection window; and
transmit the screen image information to the display apparatus,
the first circuitry of the display apparatus being configured to:
receive the screen image information from the server; and
display the collective view based on the screen image information.

6. A display method comprising:
displaying, on a display, a selection window selectively presenting a plurality of attributes of objects included in one or more pages;
receiving an operation of selecting an attribute from the plurality of attributes on the selection window; and
displaying a collective view of one or more pages each of which is associated with the attribute selected on the selection window.
